(19) United States
(12) Patent Application Publication
(10) Pub. No.: US 2024/0412058 A1
(43) Pub. Date: Dec. 12, 2024

(54) GOVERNANCE FRAMEWORK FOR MULTI-MODAL NETWORK QUERIES

(71) Applicant: Tellagence, Inc., Oregon City, OR (US)

(72) Inventors: Nitin Mayande, Oregon City, OR (US); Sharookh Daruwalla, Oregon City, OR (US)

(73) Assignee: Tellagence, Inc., Oregon City, OR (US)

(21) Appl. No.: 18/239,058

(22) Filed: Aug. 28, 2023

Related U.S. Application Data
(60) Provisional application No. 63/506,690, filed on Jun. 7, 2023.

(51) Int. Cl. G06N 3/08; G06F 16/2455

(52) U.S. Cl. CPC G06N 3/08; G06F 16/24564

(57) ABSTRACT

Systems that employ a plurality of machine learning (ML) models to respond to user queries utilize a governance framework. In embodiments, the governance framework may analyze an initial query for policy compliance, and then route the query or its components to one or more of the ML models for processing. The results from the ML models are then analyzed for policy compliance, and also to determine whether the responses are sane, factually correct, and not hallucinations. Other embodiments may be described and/or claimed.

### CROSS-REFERENCE TO RELATED APPLICATIONS

This application claims priority to U.S. Provisional Patent Application No. 63/506,690, filed on 7 Jun. 2023, the entire contents of which are incorporated by this reference as if set forth herein.

### TECHNICAL FIELD

Disclosed embodiments are directed to machine learning systems, and more specifically to a governance framework for queries made to multi-modal network systems.

### BACKGROUND

Machine learning (ML) is a broad category of software approaches that are utilized in many of today's computing contexts, such as search engines and decision making tools. ML, in relatively straightforward implementations, may encompass algorithmically-driven data sources, such as a search engine. These data sources may pull from a wide base of information to drive informed interactions with users, sometimes relying upon information specific to a given user to provide tailored responses. More sophisticated ML approaches may incorporate forms of artificial intelligence (AI) to provide predictive responses. AI may take the form of one or more neural networks, which can be simplistically understood to comprise a plurality of interconnected decision nodes which propagate information using a series of weighted factors. Today's neural networks (NN) are sophisticated architectures that come in a variety of different implementations, and can handle a wide variety of generalized problems. For example, ChatGPT, a large language model and an example of generative AI, can synthesize answers to a variety of textual queries, drawing upon a vast set of training data to formulate novel material. Likewise, convolutional NN-based architectures are adept at understanding images and/or detecting objects, which may be employed for a variety of tasks presented in the context of a dynamic and changing environment, such as automated driving. As the field of AI continues to advance, generative AI systems increasingly can mimic traditionally human traits such as creativity.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a first example system for accepting user queries to machine learning models that are coordinated by a governance framework, according to various embodiments.

FIG. 2 is a block diagram of an example query classifier for use with the governance framework of FIG. 1, according to various embodiments.

FIG. 3 is a block diagram of a second example system for accepting user queries to machine learning models that are coordinated by a governance framework, according to various embodiments.

FIG. 4 is a flowchart of the operations of a method for processing a query to machine learning models through a governance framework, according to various embodiments.

FIG. 5 is a block diagram of an example computer that can be used to implement some or all of the components of the disclosed systems and methods, according to various embodiments.

FIG. 6 is a block diagram of a computer-readable storage medium that can be used to implement some of the components of the system or methods disclosed herein, according to various embodiments.

### DETAILED DESCRIPTION

Current ML models can be thought of as software programs that perform specific tasks well. ML models may include any suitable algorithm, process, or program that is configured or otherwise intended to process data and reach a result or otherwise solve a problem with reference to some knowledge base or other information source. To illustrate by example, some ML models may include databases, artificial neural networks, tunable algorithms, or similar types of programs that can be adapted to solve a class of problems without needing to provide an algorithm specific to a given question or problem. ML is a blanket class that includes such domains as artificial intelligence (AI), which itself may include a variety of different types of artificial neural networks. Depending on how ML models are configured, they may be limited in the scope of their responses to specific information domains with which they are equipped or trained, and/or to specific modalities (e.g. images, text, video, audio, etc.). To provide a valid answer to a user query, then, the user query would need to be limited to only those information domains and modalities to which a given ML model is configured to answer.

Alternatively, some ML models may be trained on a wide spectrum or large amount of information. Where such ML models are implemented with an artificial neural network, such models may be large in terms of depth of layers as well as number of trainable parameters. These large sizes can require a relatively long time to train, necessitating significant compute resources, and requiring a large amount of training data (with its commensurate storage requirements) to achieve acceptable accuracy. These drawbacks are again experienced if the model needs to be retrained. Large models typically also wind up with a monolithic, non-fault-tolerant design. Large size ML models can further pose challenges to implement in a distributed fashion, e.g. in a data center on a cluster of servers. Finally, in some implementations, unexpected answers may be provided where a particular query is ambiguous, or answers may include irrelevant information as the ML model attempts to address all possible understandings of the query.

A further limitation of current generative ML models is that they generate output in response to a query without an understanding of what the output means. In the model's perspective, it provides predictions/outputs that make the most sense based on mathematical equations that are tuned to maximize the likelihood that a particular prediction based on previous input is correct. For example, many state-of-the-art large language models (LLM), such as the aforementioned ChatGPT, are essentially text generators based on training probabilities of what word(s) or letter(s) most-likely come next. For at least these reasons, generative ML models do not typically have an awareness of various factors that may determine whether a generated output is actually an appropriate response to an input query. Current neural networks (NN) typically cannot be relied upon to provide predictions that are accurate or trustworthy. This deficiency is, to some extent, a result of generative AI design. While the typical artificial neural networks (ANN) that form the basis of most generative AI systems are trained to determine output reflecting word-generation probabilities, they are not designed to verify if the text they are generating is true or should be generated (e.g. safe or legal information), or is even gibberish or nonsense.

These shortcomings may be addressed by harnessing the functionality of multiple learning network types, such as by connecting different architectures (and models) together to work as one “intelligent network”. The different architectures and models may be trained on different information domains and/or may each accept a different modality. Utilizing multiple ML models or network types can also address the shortcomings of a large monolithic ML model. Each of the multiple network types can be implemented using a smaller model, which can be trained (or retrained) relatively rapidly with a small data set. Employing multiple models in concert, and in some implementations multiple versions of the same model trained on the same data, can allow for fault-tolerant systems where the failure of one or a few of the models can still allow for queries to be properly addressed. Further, multiple models may be more readily distributed across multiple servers and/or multiple data centers, further increasing fault tolerance in the case of a hardware failure of one of the servers. Multiple smaller models can also enable a modular approach, where additional ML models can be added to a system to expand and enhance functionality.

The outputs may further be verified against a number of criteria, including but not limited to, if the responses are factually true (not hallucinations), safe to be generated (legal), not in violation of any terms of use or service, any other criteria as chosen by the governance framework administrator, and/or otherwise inappropriate. Solving these two shortcomings enables creating a more powerful AI tool that is not only capable across multiple modes and dimensions but also safe, trustworthy, and adaptable to any custom needs.

Disclosed embodiments include a governance framework or platform that combines a plurality of ML models, referred to herein as application specific networks (ASNs), with various supervision modules that enable an improved understanding of a user query. User queries or components of a query may, in embodiments, be submitted to a number of ASNs in communication with the governance framework that may be trained on different information domains and/or modalities. The governance framework may cross-check the results from the various ASNs against each other to help ensure correct understanding of the user query. The governance framework may include supervision or governance modules that each may employ one or more ML models to better understand and process the ASN results. Further, the supervision or governance modules may verify results for truthfulness, sanity, legality, suitability, and any other necessary aspects to ensure the integrity of the final answer provided to a user in response to the user's query.

Disclosed embodiments of the governance framework are conceptually similar to current operating systems that allow individual programs to run on top of them, providing management of system resources, ensuring proper application behavior, and shutting down applications that threaten system integrity. Similarly, the governance framework also enables modular functionality, supporting a kind of app store for ML models and providing a platform to build and distribute various models trained on various datasets similar to ones seen on mobile or desktop operating systems. A user could thus expand a given ML-based system with different ASNs trained on different types of data sets and to accept various different modalities. Furthermore, various options for compliance rules to be implemented by a given governance framework could likewise be available within the same or a similar app store. For example, a user may be able to download a set of rules or ML model for a compliance module of the governance framework that would help ensure ASN responses complied with the legal requirements of a given jurisdiction.

More broadly, in some embodiments the governance framework may be implemented as a “plug and play” type of platform where one can connect and configure various available ASN models, trained on various data, and use all the connected models together to provide the most informed prediction for a user query. Any of the blocks or functionality within the disclosed governance framework can be implemented using algorithms, rules, ANNs, a combination of the foregoing, and/or any other suitable techniques to evaluate its required functions per the configured rules. As will be understood, training would be required if one or more ASNs are implemented using a learning model, e.g. ANN, to perform its functions. Other possible embodiments will be described herein.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

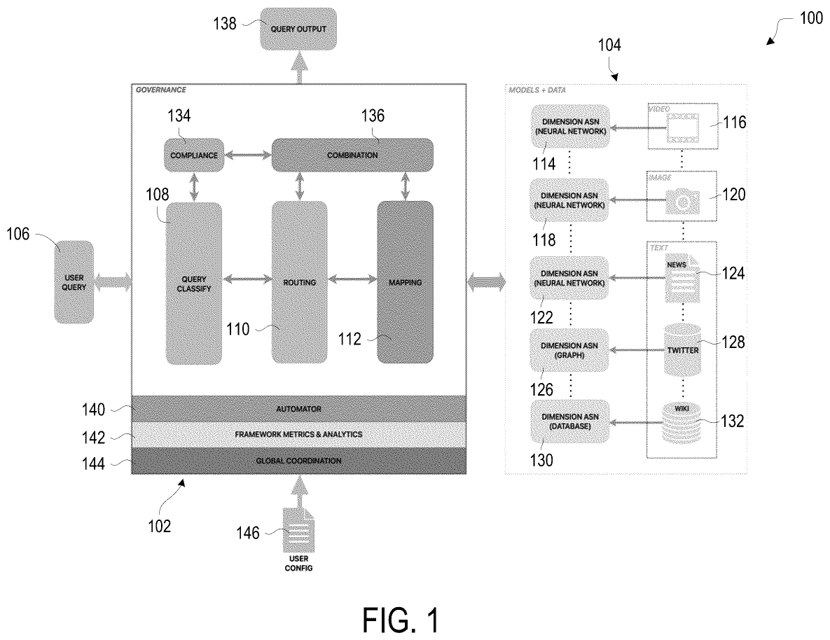

FIG. 1 illustrates a block diagram of an example system 100 that incorporates multiple machine learning modules of a variety of modalities, that are collectively queried by a governance framework 102. In embodiments of system 100, governance framework 102 acts as the moderator or controller of one or more ASNs 104. Functionally, governance framework 102 accepts as input a query 106 from a user. The query 106 may then be passed to a query classifier block 108, which breaks down the query into one or more component parts. These parts may then be passed to a routing block 110, which determines which of the one or more component parts are to be processed, and whether there are portions of the query that need to be inferred. These component parts may then be passed to a mapping block 112, which is aware of the types and nature of ASNs 104 that are connected to the governance framework 102. Mapping block 112 determines which of the ASNs 104 are appropriate for processing the query component parts, and may dispatch the component parts accordingly. Once the selected ASNs 104 return results, the mapping block 112 may determine that all component parts of the user query 106 have been satisfied, or may determine that one or more components need to be cross-checked, restructured, and/or further refined by one or more ASNs 104. If the mapping block 112 determines that all component parts have been satisfied, it may pass the responses from the ASNs 104 to a combination block 136, which may format and assemble the responses into a coherent answer. The combination block 136 may pass the answer to a compliance block 134, which may assess the proposed answer for compliance with any pertinent rules, e.g. whether the answer complies with applicable laws and regulations, whether the answer is factually correct or likely to be a hallucination, etc. The compliance block 134 may also assess, prior to submission to the routing block 110, whether the query itself complies with any pertinent regulations, e.g. whether the query as asking how to do something illegal or against an established policy. Once the coherent answer is verified and passes the compliance block 134, it may be provided to the user as query output 138.

It can be seen in FIG. 1 that the various blocks are connected with double arrows, indicating that data may flow between blocks as a given query 106 is processed. For example, a user may enter a query that is ambiguous or otherwise requires clarification. Initial processing through the various blocks of governance framework 102 may expose these ambiguities, and prompt the governance framework 102 to engage in a conversation with the user to provide additional context or clarification for query 106. Also, in some cases processing of the query 106 may be an iterative process between the various blocks of governance framework 102. For example, initial results obtained from ASNs 104 may uncover inconsistencies or ambiguities, or possible non-compliances, when analyzed by the compliance block 134. In other embodiments, another block may include analytical functionality in addition or in alternative to compliance block 134, depending on the specifics of a given implementation. These anomalies may require generating and submitting additional internal queries to one or more ASNs 104, which in turn are fed back to the blocks of the governance framework 102 for further processing to reach a coherent answer. These internal exchanges may iterate multiple times between various blocks of the governance framework 102 and/or ASNs 104 as necessary to reach a coherent answer.

In addition to the blocks described above, governance framework 102 in the depicted embodiment further includes an automator module 140, a framework metrics and analytics module 142, and a global coordination module 144. The global coordination module 144 is responsible for all coordination and synchronization activities between the various modules described above. The metrics and analytics module 142 provides metrics and analytical data, in a privacy-first form, for framework administrators; this data may also be employed in conjunction with the global coordination module 144 and automator module 140 to provide self-tuning and self-optimization functionality. The automator module 140, in conjunction with the global coordination module 144, allows the specification of a sequence of events to be executed to automate one or more functions of the governance framework 102, such as automatic tuning and/or maintenance, e.g. adjusting or dynamically training ANNs that may be used to implement some or all of the modules of the governance framework 102 and/or ASNs 104. Finally, user configuration 146 may feed into the governance framework 102, such as the global coordination module 144, to provide for user tuning and/or adjustment of various operations and performance characteristics of the governance framework 102 and any associated components. These various modules will be discussed in greater detail below.

The collection of ASNs 104, as illustrated in FIG. 1, may include one or multiple ML models. This collection may further include one or more different ML models, depending on the needs of a given embodiment. The different ML models may be trained on or configured with identical data sets (homogenous training/data) or different data sets (heterogeneous training/data). Two or more ML models may be of the same type (homogenous types) or different types (heterogeneous types). Thus, at least four possible permutations of collections of ASNs 104 are possible, homogenous data and type, homogenous data/heterogeneous type, heterogeneous data/homogenous type, or heterogeneous data/heterogeneous type. Within type and data, ASNs may accept or be based on different modalities, e.g. photos, video, audio, text, etc. Depending on the specifics of a given implementation, a given ASN 104 may support a single modality or multiple modalities.

In the depicted embodiment, ASNs 104 include first, second, and third dimension ASNs 114, 118, and 122, which are each implemented using a NN. Fourth dimension ASN 126 may be implemented using a graph model, and a fifth dimension ASN 130 may be implemented as a database. First dimension ASN 114 is configured to accept, provide, or otherwise process and/or classify video modalities 116. Depending on the specifics of a given embodiment, first dimension ASN 114 may accept videos as input and return an appropriate response, such as an image classification, recognized objects, a text or similar description, a matching or similar video, or another suitable response. Alternatively, ASN 114 may accept a text prompt or query, and return one or more videos that most closely match the prompt or query. Other configurations may be possible, depending upon the needs of a given embodiment. Similarly, second dimension ASN 118 is configured to accept, provide, or otherwise process and/or classify image modalities 120. ASN 118 likewise may accept images as input and return an appropriate response, similar to ASN 114, or may accept a text query and return one or more matching images.

Third, fourth, and fifth dimension ASNs 122, 126, and 130 are each configured to accept a text modality, and so may be configured to accept text queries and/or return text results, which may be in response to a text query or a query based on another suitable modality. In the case of third dimension ASN 122, the ASN is configured to accept a news feed 124 in a text format. Fourth dimension ASN 126 is configured to accept a Twitter feed 128, and fifth dimension ASN 130 is configured to accept a wiki feed 132. In some embodiments, third, fourth, and/or fifth dimension ASNs 122, 126, and 130 may be APIs granting access into their respective associated services, e.g. ASN 122 may be an API into a news feed, such as Google® News, ASN 126 may be an API into a Twitter feed, and ASN 130 may be an API feed into a wiki site. In such embodiments, submitting a query to ASN 126, for example, is essentially the same as entering the query into a Twitter search box. In other embodiments, each respective ASN may act as an intermediary, receiving and analyzing data from respective data sources.

It should be understood that the five ASNs 114, 118, 122, 126, and 130 and their associated modalities depicted in FIG. 1 are merely examples. Likewise, the types of modalities shown in FIG. 1 are merely examples. Other embodiments may have more or fewer ASNs, and each may be configured with their own modality which is the same or different from other ASNs. In some embodiments, there may be multiple ASNs of the same type and modality, trained on identical data sets, to provide redundancy. Other embodiments may employ a combination of any of the foregoing, e.g., a subset of ASNs may be of a common type, modality, and training set, while another subset may be of different types and/or modalities, yet another subset may be similar types and training data domain, but accept different modalities, etc. An example of the last subset would be a collection of ASNs that each are trained on data about cats, with one ASN being trained on cat images, another ASN trained on cat sounds, and yet another ASN being trained on cat textual data, e.g. facts, trivia, care, medical issues, etc.

The collection of ASNs 104 may interface with the governance framework 102 in a modular fashion, allowing ASNs of various types to be swapped, removed, or added. This modular nature further enables additional or alternative ASNs to be obtained via a store or library mechanism, similar to an app store, where a user could select from a variety of different compatible ML models (such as algorithms or ANNs), which may support a variety of different modalities and training sets. In some cases, the store may provide models that are pre-trained or pre-configured to use specific training data sets, enabling a user to build a custom ML system embodiment off a governance framework 102 that is tailored to the user's specific needs. In still other embodiments, the ASNs 104 of system 100 may incorporate a mix of both “off-the-shelf” models from a library and custom-trained models. Similarly, the data used to train the models (where such models are either not pre-trained, or are intended to be re-trained) may be commercially available training sets and/or custom training sets, such as a data set created for internal use by an organization implementing a system 100.

In some such implementations, each training data set may be used on one corresponding ML model. In other implementations, multiple models may be trained on a single data set, such as where multiples of the same model type, e.g. a type of ANN are provided to facilitate redundancy and load distribution across multiple servers. In still other implementations, a single data set may be used to train multiple models of different types, e.g. different types of ANNs, algorithms, databases, etc.), with the different types of models responding to different aspects of the training data set, similar to providing multiple perspectives on a single type or domain of data.

The various ASNs 104 may output responses to requests in human readable format, and/or in an intermediate format understood internally by one or more modules of the governance framework 102. The various responses may then be combined, as will be discussed below and, if necessary, formatted into a human readable format.

The query classifier (or simply, “classifier”) block 108, in embodiments, is responsible for processing the user query 106 and providing input to the next stage in the governance framework 102, namely, a routing block 110 (discussed below). The query classifier 108 breaks the user query 106 down to the contextual level such that differently worded queries that are otherwise similar at the context level result in the same ASNs 104 to be used for prediction or answering. This enables the governance framework 102 to be deterministic in its function of choosing the ASNs 104 to use for responding to a given query 106. Although the query 106 as discussed herein is primarily textual in nature, it should be understood that query 106 may be of a variety of different modalities, depending on how the governance framework 102 and/or query classifier 108 is configured. In some embodiments, a user may be able to submit an image, video, audio, or a mix of different modalities as user query 106. Depending on how query classifier 108 is configured, a single modality or multiple different modalities may be able to be processed and submitted to ASNs 104. For example, classifier 108 may be configured to accept photos, videos, and text, and analyze queries in any of these formats for submission to ASNs 104.

The query classifier 108 may, in the course of breaking down the user query 106 to ascertain its context and components, engage in an interaction with the user submitting the query 106. For example, if a query 106 is ambiguous, such as when terms with multiple possible meanings are used and there is insufficient context to ascertain which of the possible meanings the user intended, the classifier 108 may prompt the user with follow-up questions to clarify the user's intentions. These specifics of the query 106 can enable generation of a more accurate prediction from the ASNs 104. Having this interaction, in embodiments, before any learning models are engaged also improves the performance of the governance framework 102 and can improve energy utilization.

Either the ASNs 104 or the query classifier 108, or both, may indicate one or more ambiguities, depending on the nature of the query 106 and initial feedback from ASNs 104. In some instances, analysis of the user query 106 by the classifier 108 may not immediately detect an ambiguity. In such a scenario, the ambiguity may not be apparent until an initial query portion or component is dispatched to one or more ASNs 104, with the ASN response(s) indicating the ambiguity to prompt follow-up. In other scenarios where the query classifier 108 is unable to identify the scope of a query 106, or the classifier 108 otherwise determines one or more portions of the query 106 are subject to multiple possible meanings, the classifier 108 could initiate an exploratory query to the ASNs 104 to drive the follow-up. For example, if a user query 106 is “What is MPD?”, the exact query may be unclear, as the acronym MPD has multiple possible definitions, and there may be insufficient context surrounding the query 106 to ascertain a specific intended definition. In such a scenario, the query classifier 108 can either initiate a follow-up, e.g., “Please define MPD”, or can initiate and send an exploratory query to the ASNs 104 (via the various governance modules). The query classifier 108 may then follow-up with the user, possibly prompting: “These are the definitions I found-which one would you like to know more about?”, or another suitable prompt dependent upon the results from the ASNs 104. The user inputting the query 106 may then provide further clarification as to the user's intentions with the query 106. A person skilled in the art will understand this to be an iterative process, with the query classifier 108 engaging in a continuing dialog until any critical ambiguities are resolved. Alternatively, the query classifier 108 itself may be able detect possible ambiguities in the query 106 without needing to resort to ASNs 104. For example, the query 106 may be phrased in such a way as to be ambiguous or otherwise unclear, which the query classifier 106 may be able to detect.

The query classifier 108 can be implemented with algorithms, rules, one or more ANNs, a combination of the foregoing, and/or any other suitable techniques to evaluate the user query 106 per the configured rules. When implemented as an ANN, the ANN may be trained specifically to break down queries into component parts and, in some embodiments, may detect possible ambiguities, as discussed above. In some embodiments where the classifier 108 can accept multiple modalities, multiple ANNs and/or other suitable processing techniques may be employed to address each possible modality. For example, classifier 108 may include a separate ANN for each modality, e.g. one trained to break down text queries, one trained to process image queries, one trained to process audio queries, etc. In some embodiments, the functionality of classifier 108 may be expanded or tailored by adding, removing, or modifying/retraining ANNs and/or other models, such as may be obtainable from an app store, as discussed above with respect to ASNs 104.

Query classifier 108 further may take various user query 106 formats and to learn to classify the formats in a manner that is optimal for the routing block 110 to use as input. The query classifier 108 is responsible not just for breaking down a user query 106 into components that help other blocks or modules of the governance framework 102 decide which models to use, but other important details, e.g. attention to the mode or form of answer that the user is looking for and passing this information to the routing block 110. In other embodiments, query classifier 108 may pass at least part, or all, of query 106 directly to one or more ASNs 104. For example, if one or more of the ASNs 104 is configured to directly accept user-entered text (such as a prompt to ChatGPT), query classifier 108 may be able to directly pass query 106 to such an ASN. The mapping block 112, discussed below, may inform query classifier 108 as to which such ASN(s) 104 can directly accept query 106. It should be understood that query 106 may possibly be submitted in whole to multiple ASNs 104, if each such ASN 104 can directly accept query 106; each ASN 104 in turn may provide a different response to the same query 106 based on the particular knowledge domain for which the respective ASN 104 is configured to respond.

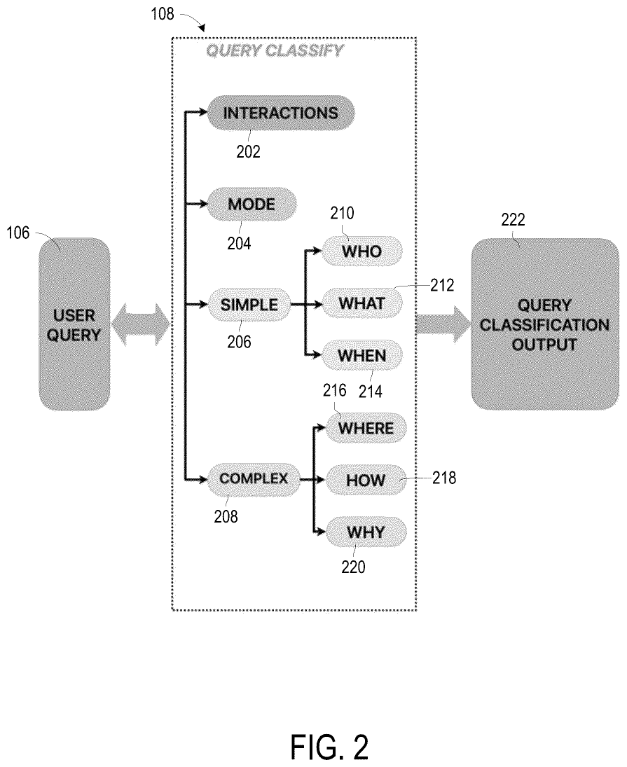

FIG. 2 illustrates how a user query 106 may be broken down and classified by query classifier 108, according to one possible embodiment. User query 106 is broken down to constituent components as well as some types of metadata. For example, the type of mode 204 characterizing the query 106 may be determined, such as whether the query is text based, video based, image based, audio based, or another type of modality. This determination may determine how the classifier 108 further processes the query 106, e.g. what sort of ML model or ANN needs to be utilized that is configured for the determined modality. Processing of the query 106 may further determine which parts are simple 206 in nature, or complex 208. Simple 206 portions of a query may include who 210, what 212, and when 214, such as “When was the president sworn in?”: the who 210 is the president, the what 212 is the president's swearing in, and the when 214 is the date the swearing in will take place. Complex 208 portions of a query may include where 216, how 218, and why 220. Using the previous examples, where 216 is the city/location where the president is to be sworn in, how 218 is the procedure by which the president is sworn in, and why 220 is the reason the president is being sworn in. As may be noted, some of these components may not be present in a given query, or may not be relevant.

As discussed above, the query classifier 108 in FIG. 2 also includes an interaction 202 block, for when analysis of the simple 206 and complex 208 aspects indicates a possible ambiguity. In addition to the various ways ambiguities may be detected as described above, in some embodiments, an ambiguity can arise if the classifier 108 is unable to parse the query into the simple 206 and/or complex 208 aspects. The interaction 202 block may coordinate obtaining the additional information from the user necessary to resolve any ambiguities and fully process the query 106. Following processing, the classifier 108 can generate a query classification output 222, which may be forwarded to the routing block 110 (discussed below). It should be understood that the classifier 108 may engage in an iterative process in coordination with the user and/or results from ASNs 104 to fully understand a given user query 106.

Turning back to FIG. 1, routing block 110, in embodiments, is responsible for the user query 106 side taking, as input, the query classification output 222 (FIG. 2) obtained from the user query 106 and processing it for the mapping block 112. The primary function of the routing block 110 is to decide what aspects of the query need to be processed or inferred, viz. what is the full question in the query 106, which may not have been fully articulated by the user. Using the previous example of “When was the president sworn in?”, questions of where, how, and why are not explicitly asked, but may nevertheless be relevant to provide a complete answer, or be implicated in a user's question. This may be determined by previous context, e.g. if a user has recently asked about the logistics of the swearing in ceremony, the governance framework 102 through the routing block 110 may infer that the user is interested not only in the direct question asked, viz. when the president is sworn in, but also the details of the swearing-in ceremony. Routing block 110 may determine these unspecified aspects and infer them as part of the query 106, and include them in the requests sent to ASNs 104. It then uses this information, in conjunction with the mapping block 112, to decide what learning models need to be used to produce an output for the query. The mapping block 112, as will be described below, then communicates with the specific learning models to enable for inference, viz. what models are required to answer the question in the query.

As with the query classifier 108, parts or all of the routing block 110 may be implemented with algorithms, rules, one or more ANNs, a combination of the foregoing, and/or any other suitable techniques. Also, the routing block 110 may interact with compliance block 134 to resolve possible inconsistencies in predictions received from ASNs 104, to help routing block 110 in determining which query aspects may be processed or inferred.

The mapping block 112, in embodiments, is primarily a gatekeeper for all the learning models, as implemented in the various ASNs 104, that are connected to the governance framework 102. It has three major functions: 1) to be aware of the different learning models connected to the framework; 2) to be aware of the framework configuration provided by the user, where the user configuration dictates which of the connected learning models are active; and 3) to work with the routing block 110 to decide which of the one or more learning models 114,118, 122, 126, and 130 (in the depicted example) that need to be enabled for the query's inference. If a user query does not require a particular ASN 104's prediction, either due to unrelated data, mode, etc, that ASN 104 may be disabled, gated, or otherwise simply ignored for the query, thereby conserving energy and complexity and improving performance. For example, a purely text mode query 106 may not need, at least initially, feedback from first dimension ASN 114, which is configured to accept video modalities, and second dimension ASN 118, which is configured to accept image modalities.

Depending on the specifics of a given embodiment, mapping block 112 may receive query components from the routing block 110 and/or query classifier 108 and dispatch to the selected ASNs 104. The mapping block 112 may further receiving and coordinating responses received from the ASNs 104, and dispatching them to other blocks or modules within governance framework 102. In other embodiments, mapping block 112 may provide mapping information to either or both of the routing block 110 and query classifier 108, which may then dispatch the query components in accordance with the provided mapping information. In still other embodiments, variations or combinations of these strategies may be employed by mapping block 112 as part of governance framework 102. As with the query classifier 108 and routing block 110, parts or all of the mapping block 112 may be implemented with algorithms, rules, one or more ANNs, a combination of the foregoing, and/or any other suitable techniques.

Compliance block 134, in embodiments, provides verification of predictions generated by the various ASNs 104 with respect to accuracy, factualness, safety, legality, trustworthiness, privacy, and/or any other aspects that may be of concern for a given implementation of system 100, such as domain-specific rules that allow ASN responses to be accurate with respect to their particular domains. Still further, compliance block 134 may, in some embodiments, analyze the initial query 106 and/or its constituent components as provided from the query classifier 108 for whether the query 106 relates to something that is illegal, in violation of organizational rules, or otherwise should not be processed by the system 100. For example, if the user query 106 is asking how to do something that is illegal, or is seeking potentially sensitive knowledge (e.g. company confidential information that a user is not authorized to access), the compliance block 134 may be configured to detect such queries and inform the user that such queries cannot be processed.

As mentioned, in embodiments compliance block 134 may verify the results provided by the various ASNs 104 in response to query 106 to detect ANN “hallucinations” and prevent them from being provided to the user as valid. In some implementations, the compliance block 134 may be able to correct a hallucination. For example, in some such implementations, the compliance block 134 may cross-check results from the ASN 104 providing the answer being verified against known primary sources, such as websites, libraries, databases, etc., to confirm the results align with information from the primary sources. Alternatively or additionally, compliance block 134 may cross-check results from the ASN 104 against one or more of the other ASNs 104, which may have the same or a different knowledge domain, to help ensure factualness and consistency. For example, a picture or call of a bird submitted by a user as query 106 may turn up a possible match from a database of birds or bird song, but may be excluded if cross-checking against a database that is trained to understand bird locations indicates that the possible match is not reasonably located in the geographic region that the picture or call was taken.

As with the query classifier 108, routing block 110, and mapping block 112, parts or all of the compliance block 134 may be implemented with algorithms, rules, one or more ANNs, a combination of the foregoing, and/or any other suitable techniques.

The one or more ANNs, or other ML models, may be added or removed from the compliance block 134 in a modular fashion, such as from an app store or library where a variety of models pre-trained for a variety of different compliance domains, and/or trainable models, may be available, and selected based upon the particular compliance needs for a given implementation of system 100. For example, one module for compliance block 134 could be trained to ascertain compliance with the laws of a particular state (e.g., California, New York, Illinois, etc.), nation (e.g. US, UK, China, etc.), a particular area of law (e.g. securities law, criminal law, corporate law, intellectual property), and/or a combination of the foregoing (e.g., China intellectual property law, California criminal law, etc.). In some embodiments, multiple ANNs and/or other ML models may be employed as part of the compliance block 134 to allow compliance confirmation with multiple domains, or to achieve a combination (e.g. an ANN trained for criminal compliance could be cross-checked with an ANN trained for California law to ensure compliance with California criminal law, provided the ANN domains overlap sufficiently). Furthermore, the compliance block 134 may also provide domain-specific checks to the output of the various ASNs 104. The compliance block 134 may also, in embodiments, be responsible for ensuring that responses from ASNs 104 adhere to data privacy requirements, both in terms of personal or private information as well as the interactions users have with the framework.

Still further, in some embodiments the compliance block 134 may at least partially provide compliance by performing cross-checks between the various ASNs 104. One example is described above, where an output from an ASN 104 such as specifications about a product can be checked against a primary source, such as the manufacturer's website or another unrelated ASN 104 that also included product information. In such an embodiment, the primary source of the manufacturer's website may be considered or included as an ASN 104, such as an API into a website, discussed above with respect to ASNs 104. In other embodiments, the cross-checking of the compliance block 134 may be performed across multiple ASNs 104, with a consensus being ascertained from the responses to help ensure factual compliance.

Where the compliance block 134 determines that a query 106 is illegal or otherwise in violation of some policy, is unsafe, etc., governance framework 102 may reject the query and/or notify the user that the query 106 cannot be processed. In some instances, compliance block 134 may determine that only a portion of the query 106 is out of compliance. In such an event, governance framework 102 may notify the user of the non-compliant portions that cannot be answered, so that the user can revise or retract the query 106. Alternatively, the governance framework 102 may only process those portions of query 106 that are compliant, and notify the user of those portions that could not be answered.

Where the compliance block 134 determines that a response or responses from the ASNs 104 are not in compliance (such as being hallucinations or factually incorrect), governance framework 102 may use a consensus approach as discussed above, or another suitable approach, to try and resolve the non-compliant response or responses and bring them into compliance. Likewise, where only some portions of a response or responses from ASNs 104 may not be in compliance, the governance framework 102 may attempt to resolve those non-compliant portions. Alternatively, governance framework 102 may determine to omit the non-compliant portions from the query output 138, or include them but flag or highlight them as questionable or otherwise explain how the portions fail to meet the compliance requirements. In some embodiments, compliance block 134 may assign a weight or confidence score to one or more portions or all of the responses from ASNs 104.

The combination block 136 is responsible for merging the predictions provided by the learning models 114,118, 122, 126, and 130 into query output 138. In conjunction with the compliance block 134, the combination block 136 also verifies the predictions provided by the various learning models selected by mapping block 112, as described above. The combination block 136 may carry out any editing, flagging, or omitting of non-compliant portions of responses from the ASNs 104, as discussed immediately above, in preparing the query output 138. Further, in embodiments the combination block 136 decides the “right mix” of the various predictions provided by the models before providing the “final” prediction for the user query as query output 138. When there are multiple outputs for a given query, such as from multiple learning models/ASNs 104, not all the outputs need to be sent to the user. By “right mix” is meant taking part/whole of the individual outputs to form a singular/coherent query output 138 for the user query, which has been verified by the compliance block 134. Further, the “right mix” can also be influenced by the user configuration 146 input into the governance framework 102 which may indicate a preference or priority for outputs from ASNs 104 that have specific learning model(s). The final query output 138 may be presented in a user-readable format.

As with the query classifier 108, routing block 110, mapping block 112, and compliance block 134, combination block 136 may be implemented with algorithms, rules, one or more ANNs, a combination of the foregoing, and/or any other suitable techniques.

Automator module 140, in embodiments, allows for a sequence of operations within governance framework 102 and its constituent components to be automatically performed. In some embodiments, automator module 140 can be enabled via a scripting engine such as Java. In other embodiments, automator module 140 may employ a “learning model” paradigm, where the module 140 could learn sequences of events that tend to recur in various operations. Automator module 140 could also work with the metrics & analytics module 142, discussed below, to provide a form of self-tuning/self-optimization for the governance framework 102 and/or system 100. For example, if the automator module 140 is aware of desired performance characteristics, it could make, or cause, adjustments to be made to various components of system 100 if the metrics & analytics module 142 indicates that the system 100 or governance framework 102 is not performing in accordance with the desired performance characteristics. These details may be specified in user configuration 146.

Metrics and analytics module 142, in embodiments, provides metrics and analytical data, in a privacy-first form, about the governance framework 102 and, in some embodiments, system 100, to include the various ASNs 104. In implementations where data privacy is of concern, no personal or private data is collected or provided; only data related to how the governance framework 102 is being utilized by a user or is otherwise performing. The metrics and analytics module 142 collects and provides information on the inner workings of the various governance framework 102 blocks and other components as well as provides information that allows improving performance. For example, if the mapping block 112 is biased towards a specific (or set of) ASN 104 learning model(s) for inference, the metrics & analytics module 142 would be able to provide this information to an administrator of the system 100 and/or governance framework 102, to tweak its performance if necessary. Likewise, if ASNs 104 implementing specific learning models should be preferentially used because they are updated more frequently or utilize more reliable data sources, then such preference can be verified with the metrics collected by the metrics and analytics module 142, and corrected if not performing as intended. Such correction or adjustments may be performed, as mentioned above, by automator module 140.

Global coordination module 144, in embodiments, is responsible for all coordination and synchronization activities between the various stages and components of the governance framework 102. Global coordination module 144 also monitors, sets priorities, interrupt processes, etc., while directing the governance framework 102 in executing one or more user queries 106. In conjunction with automator module 140, it can coordinate a sequence of events within the governance framework 102 to enable further automation of events that may be facilitated by system 100, e.g. book reservations based on a travel itinerary suggested by the various ASNs 104, enable follow-up actions for ASNs 104 based on predictions provided by them, etc.

In some embodiments, automator module 140 and/or global coordination module 144 (or global coordinator) may work in conjunction with metrics and analytics module 142 to self-optimize or otherwise tune the operation of governance framework 102, including adjustment of any parameters of the various components of governance framework 102 described above. In embodiments, this self-optimization may be directed, informed, or otherwise controlled by user configuration 146 (discussed below), which may provide direction to how the governance framework 102 should perform or otherwise be tuned.

The user configuration 146 may be employed at least by global coordination module 144 to adjust performance characteristics and behaviors of the governance framework 102. User configuration 146 may be implemented in any suitable fashion. In some embodiments, user configuration 146 may be a file or similar structure that includes parameters and/or other information adjustable by a user or administrator of system 100 and/or governance framework 102 to achieve a desired behavior or performance. In some embodiments, these parameters and/or adjustable information may further allow adjusting of performance characteristics and behaviors of the various individual blocks within the governance framework 102. For example, compliance block 134 may have parameters such as behaviors in response to non-compliance that may be tuned via user configuration 146. Similarly, in some embodiments, routing block 110 may have parameters that adjust what inferences can be made from a query.

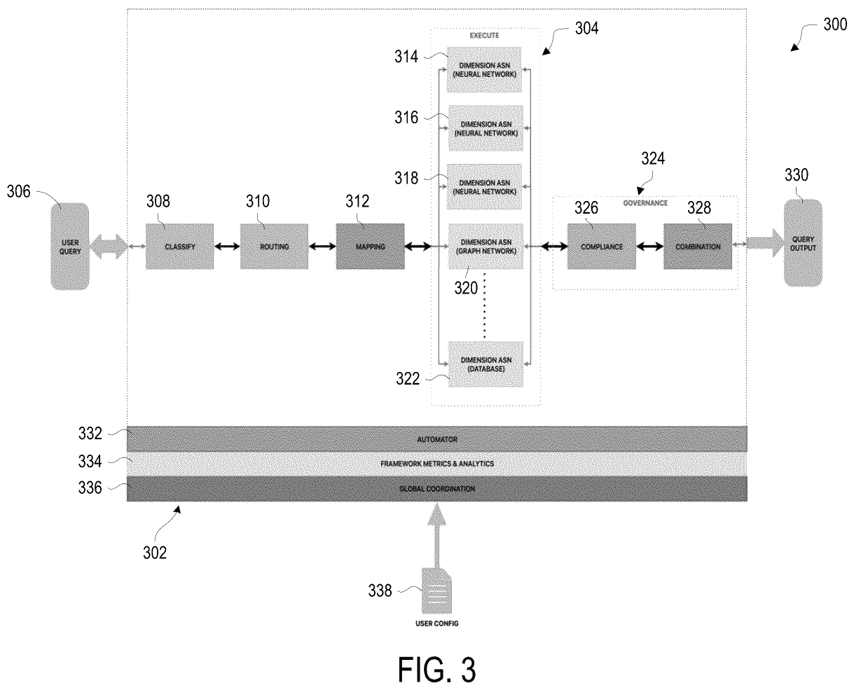

FIG. 3 illustrates a second possible implementation of a machine learning system 300 with a governance framework 302. System 300 is functionally comparable to system 100, except implementing the various components in more of a “pipeline” style, reflecting how data may flow in some embodiments of system 300. As can be seen, system 300 includes one or more ASNs 304, which may include first, second and third dimension ASNs 314, 316, and 318 which are neural networks, a fourth dimension ASN 320 which is a graph network, and a fifth dimension ASN 322 which is a database. As with ASNs 104, these ASN types are merely representative, and the number and type of ASNs 304 may vary depending on the needs of a given embodiment.

Governance framework 302 accepts a user query 306, which is received by a classifier block 308. The classifier block 308 communicates with a routing block 310, which in turn communicates with a mapping block 312, which understands and coordinates submissions to the various ASNs 304. Results from the ASNs 304 in turn communicate to a compliance block 326, and are combined in combination block 328 to form query output 330. As can be seen with the various two-way arrows, data may flow in either direction depending upon results provided by the various blocks and ASNs, similar to the interactions described above with respect to FIG. 1.

The various blocks 308, 310, 312, 326, and 328 each function and may be implemented in a comparable fashion to corresponding blocks 108 (classifier), 110 (routing), 112 (mapping), 134 (compliance), and 136 (combination) of FIG. 1, respectively. The compliance block 326 and combination block 328 may, in embodiments, be implemented as a combined governance block 324. Governance framework 302 also includes automator module 332, metrics and analytics module 334, and global coordination module 336, with functionality and implementation comparable to automator module 140, metrics and analytics module 142, and global coordination module 144 of FIG. 1. The governance framework 302 may accept a user configuration 338, similar to user configuration 146 of FIG. 1.

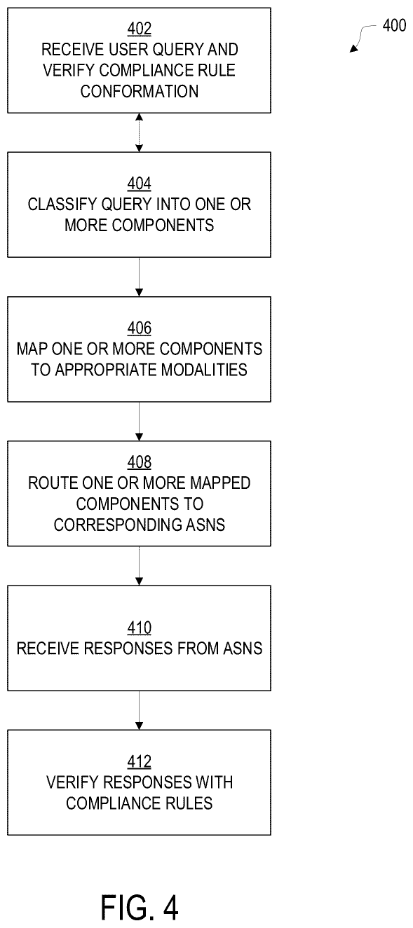

FIG. 4 is an example method 400 of the operations for processing a user query against a collection of ASNs, such as ASNs 104 or 304, through a governance framework, such as governance framework 102 or 302. The operations of method 400 may be carried out in whole or in part, depending upon the needs of a given embodiment. Further some operations may be omitted, some operations may be added, and the order of operations may be rearranged depending upon the requirements of a given embodiment. The operations of method 400 may be carried out by one or more components of a system, such as system 100 (FIG. 1) or system 300 (FIG. 3). Some or all operations may be carried out by a server, or by a device within the structure, or both. Much of the functionality described below in each operation corresponds with various blocks and modules described above with respect to FIGS. 1 and 2, and the reader is directed to the foregoing description of the same. Moreover, some aspects of a given operation may be instead carried out as part of a different operation, depending upon the specifics of a given implementing system.

In operation 402, a user query is received at a governance framework, and is analyzed to determine whether the query is in compliance with any required rules. For example, the user query may be analyzed to ensure it is not seeking information on how to carry out illegal or unethical activities, does not seek to uncover controlled information that the user is not authorized to view, is not asking a question that is prohibited by the policies of an administrator of the implementing system, is not asking a non-sensical question (such as if the query was mistyped and cannot be deciphered), etc. If the query is determined to be out of compliance, depending on the embodiment, the query may be rejected, the user may be warned about the non-compliance, and/or the user may be prompted to revise the query, possibly with information as to how the query may be made compliant. In some embodiments, the user may be provided information or referred to information about the policies required for compliance.

In operation 404, once the query is determined to be compliant, it is passed through a classifier to break it down into one or more constituent components, identifying various aspects such as who, what, where, when, why, and how. The classifier may identify possible ambiguities in the query, and highlight or flag these ambiguities for resolution. Resolution may involve prompting the user to provide additional details or clarification of the query, which may be accomplished by reverting back to operation 402, where the clarification is received and analyzed for policy compliance, before being further processed by the classifier in operation 404. Furthermore, operation 404 may also analyze the query for any unstated portions that can be inferred, e.g. asking about movie times may automatically infer an unstated geographic location or area to determine movie times, as a person querying movies is unlikely to be interested in movie times at theaters that are geographically distant.

In operation 406, the one or more query components resulting from operations 402 and 404 are analyzed for nature and modalities, and mapped to appropriate ASNs for processing. For example, a picture as part of the query may be mapped to one or more ASNs that can receive and process images. A text request requiring textual creation may be mapped to an ASN that is a generative large language model NN, while a text request for a company's contact information may be mapped to an ASN that interfaces with the company's website, or a database that includes business contact information.

In operation 408, the mappings are used to route and dispatch the query or one or more query components to the appropriate ASNs for processing. Depending on the particulars of a given ASN and system embodiment, the query or query components may be provided as originally entered by the user to operation 402, or may be provided in an encoded fashion that the ASN is configured to accept.

In operation 410, responses are received from the various ASNs as they complete processing the queries. As mentioned above, the responses may indicate the detection of an ambiguity in the query, and may be used to engage the user to clarify the query.

In operation 412, the received responses are checked for compliance with any required rules, as well as for whether the responses are sane and factual (not hallucinations), in addition to other possible aspects. In some instances, responses from one particular ASN may be cross-fed into other ASNs in operation 410, to provide a sanity check. For example, where one of the ASNs is a primary source of information, query results from a separate ASN that touches upon information within the primary source domain may be verified with the primary source ASN to confirm it is factually correct. Once the responses are verified as being in compliance, the responses may be formatted into a final query results for providing to the user who entered the initial query.

It should be appreciated that, as discussed above with respect to the various blocks and modules described in FIG. 1, the various operations may be performed iteratively. For example, compliance operation 412 may reveal that the initial query seeks confidential or illegal information, which was not otherwise detectable until processed through one or more ASNs. In such an event, method 400 may revert back to block 402, where a user would be notified of the detected non-compliance and be prompted to revise the query.

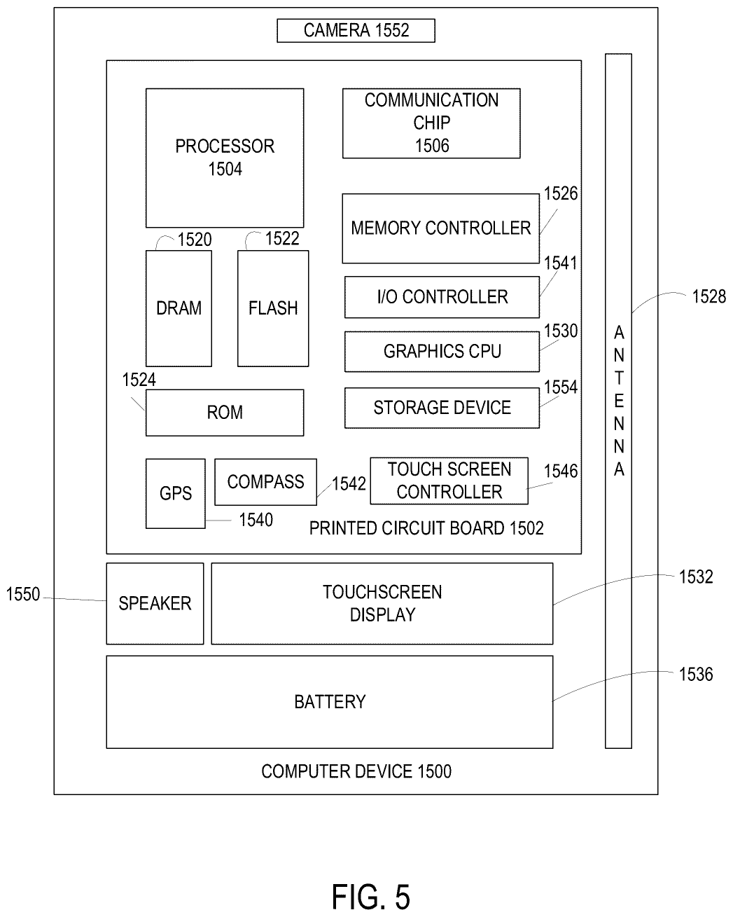

FIG. 5 illustrates an example computer device 1500 that may be employed by the apparatuses and/or methods described herein, in accordance with various embodiments. As shown, computer device 1500 may include a number of components, such as one or more processor(s) 1504 (one shown) and at least one communication chip 1506. In various embodiments, one or more processor(s) 1504 each may include one or more processor cores. In various embodiments, the one or more processor(s) 1504 may include hardware accelerators to complement the one or more processor cores. In various embodiments, the at least one communication chip 1506 may be physically and electrically coupled to the one or more processor(s) 1504. In further implementations, the communication chip 1506 may be part of the one or more processor(s) 1504. In various embodiments, computer device 1500 may include printed circuit board (PCB) 1502. For these embodiments, the one or more processor(s) 1504 and communication chip 1506 may be disposed thereon. In alternate embodiments, the various components may be coupled without the employment of PCB 1502.

Depending on its applications, computer device 1500 may include other components that may be physically and electrically coupled to the PCB 1502. These other components may include, but are not limited to, memory controller 1526, volatile memory (e.g., dynamic random access memory (DRAM) 1520), non-volatile memory such as read only memory (ROM) 1524, flash memory 1522, storage device 1554 (e.g., a hard-disk drive (HDD)), an I/O controller 1541, a digital signal processor (not shown), a crypto processor (not shown), a graphics processor 1530, one or more antennae 1528, a display, a touch screen display 1532, a touch screen controller 1546, a battery 1536, an audio codec (not shown), a video codec (not shown), a global positioning system (GPS) device 1540, a compass 1542, an accelerometer (not shown), a gyroscope (not shown), a depth sensor 1548, a speaker 1550, a camera 1552, and a mass storage device (such as hard disk drive, a solid state drive, compact disk (CD), digital versatile disk (DVD)) (not shown), and so forth.

In some embodiments, the one or more processor(s) 1504, flash memory 1522, and/or storage device 1554 may include associated firmware (not shown) storing programming instructions configured to enable computer device 1500, in response to execution of the programming instructions by one or more processor(s) 1504, to practice all or selected aspects of system 100, system 300, or method 400 described above. In various embodiments, these aspects may additionally or alternatively be implemented using hardware separate from the one or more processor(s) 1504, flash memory 1522, or storage device 1554.

The communication chips 1506 may enable wired and/or wireless communications for the transfer of data to and from the computer device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 1500 may include a plurality of communication chips 1506. For instance, a first communication chip 1506 may be dedicated to shorter range wireless communications such as Wi-Fi and Bluetooth, and a second communication chip 1506 may be dedicated to longer range wireless communications such as GPS, EDGE, GPRS, CDMA, WiMAX, LTE, Ev-DO, and others.

In various implementations, the computer device 1500 may be a laptop, a netbook, a notebook, an ultrabook, a smartphone, a computer tablet, a personal digital assistant (PDA), a desktop computer, smart glasses, or a server. In further implementations, the computer device 1500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

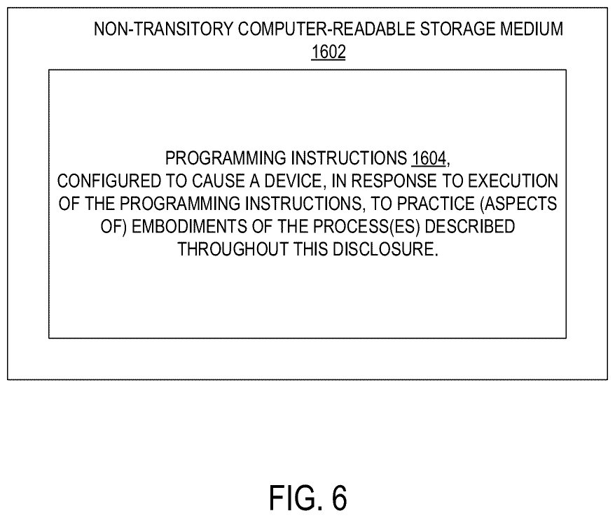

FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 1602 may include a number of programming instructions 1604. Programming instructions 1604 may be configured to enable a device, e.g., computer 1500, in response to execution of the programming instructions, to implement (aspects of) system 100, system 300, or method 400 described above. In alternate embodiments, programming instructions 1604 may be disposed on multiple computer-readable non-transitory storage media 1602 instead. In still other embodiments, programming instructions 1604 may be disposed on computer-readable transitory storage media 1602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
classifying, by a governance framework, a user query into one or more constituent components;
mapping, by the governance framework, the one or more constituent components to one or more different modalities;
routing, by the governance framework, the one or more constituent components to one or more modal application specific networks (ASNs) each corresponding to one of the one or more different modalities;
combining, by the governance framework, results received from the one or more modal ASNs into a unified response to the user query; and
verifying, by the governance framework, the results received from the one or more modal ASNs with one or more compliance rules.

2. The method of claim 1, further comprising providing, by the governance framework, the unified response to a user.

3. The method of claim 1, further comprising:
verifying, by the governance framework, the user query for compliance with the one or more compliance rules; and
rejecting, by the governance framework, the user query if it fails to comply with at least one of the one or more compliance rules.

4. The method of claim 1, wherein classifying the user query into one or more constituent components comprises providing the user query to one or more artificial neural networks (ANNs) for classification.

5. The method of claim 4, wherein the routing of the one or more constituent components to the one or more modal ASNs is based upon the classification from the one or more ANNs.

6. The method of 1, further comprising:
receiving, from the one or more modal ASNs, corresponding one or more results;
analyzing, by the governance framework, the corresponding one or more results to ascertain one or more additional queries;
submitting, by the governance framework, the one or more additional queries to one or more of the modal ASNs; and
receiving, from the one or more modal ASNs, revised results.

7. The method of claim 6, wherein verifying results received from the one or more modal ASNs with the one or more compliance rules comprises verifying the revised results with the one or more compliance rules.

8. A non-transitory computer-readable medium (CRM) comprising instructions that, when executed by a processor of an apparatus, cause the apparatus to provide a governance framework to:
classify a user query into one or more constituent components;
map the one or more constituent components to one or more different modalities;
route the one or more constituent components to one or more modal application specific networks (ASNs) each corresponding to one of the one or more different modalities;
combine results received from the one or more modal ASNs into a unified response to the user query; and
verify the results received from the one or more modal ASNs with one or more compliance rules.

9. The CRM of claim 8, wherein the instructions are to further cause the governance framework to cross-check the results of one of the one or more modal ASNs with another of the one or more modal ASNs.

10. The CRM of claim 8, wherein the instructions are to further cause the apparatus to read a configuration from a user configuration file, and adjust operation of the governance framework according to the configuration.

11. The CRM of claim 8, wherein the instructions are to further cause the apparatus to automate one or more operations of the governance framework

12. A system, comprising:
a plurality of application specific networks (ASNs), wherein at least a subset of the plurality of ASNs accept queries of different modalities; and
a governance framework coupled to the plurality of ASNs, the governance framework comprised of components that include:
a classifier to break down a user query received at the system into one or more components;
a mapper to determine which aspects of the user query are to be processed or inferred;
a router to select one or more ASNs from the plurality of ASNs based on relevant modalities of the user query and dispatch corresponding components of the user query; and
a compliance verifier.

13. The system of claim 12, wherein one or more of the plurality of ASNs are located remote from the governance framework.

14. The system of claim 12, wherein at least one of the plurality of ASNs is implemented as an artificial neural network (ANN).

15. The system of claim 14, wherein a subset plurality of the plurality of ASNs are implemented as ANNs that accept a common modality.

16. The system of claim 12, wherein one or more of the classifier, mapper, router, and compliance verifier are implemented as ANNs.

17. The system of claim 12, wherein at least one of the plurality of ASNs is of a different type from at least another of the plurality of ASNs.

18. The system of claim 12, further comprising a user configuration to modify the functionality of one or more of the components of the governance framework.

19. The system of claim 12, further comprising a metrics and analytics module to collect metrics on the performance of the governance framework.

20. The system of claim 12, wherein the classifier is to resolve ambiguities in the user query.

21. The system of claim 12, further comprising a global coordinator to coordinate and synchronize actions of the components of the governance framework.

22. The system of claim 21, further comprising an automator to perform actions with the components of the governance framework as directed by the global coordinator.

23. The system of claim 19, further comprising an automator and a global coordinator, wherein the automator and global coordinator are to adjust operations of the governance framework in response to the collected metrics to achieve a desired performance.

24. The system of claim 23, wherein the desired performance is specified in a user configuration.

25. The system of claim 23, wherein to adjust operations of the governance framework comprises adjusting parameters of one or more of the components of the governance framework.
